(19) United States
(12) Patent Application Publication
(10) Pub. No.: US 2010/0323667 A1
(43) Pub. Date: Dec. 23, 2010

(54) METHOD AND APPARATUS FOR IN-APPLICATION NOTICE OF INDEPENDENT MESSAGE

(75) Inventors: Christian Oschwald, Berlin (DE); Andreas Follmann, Berlin (DE); Matthew Ling, Berlin (DE); Harri Kristian Wikberg, Helsinki (FI); Jeanny Wang, Berlin (DE); Norbert Riedelsheimer, Berlin (DE)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/489,896

(22) Filed: Jun. 23, 2009

(51) Int. Cl. G06F 9/445; H04M 3/42; G06F 15/16; G06F 9/46

(52) U.S. Cl. 455/412.2; 709/206; 717/178; 709/204; 719/313

(57) ABSTRACT

An approach is provided for monitoring a messaging service for arrival of a message at an apparatus. It is determined whether the message indicates an installed application that is installed on the apparatus and is different from the messaging service. If the message indicates the installed application, then removal is initiated of the message from a queue of received messages for the external messaging service and selecting one or more actions for the application based on the message.

### BACKGROUND

Wireless (e.g., cellular) service providers and device manufacturers are continually challenged to deliver value and convenience to consumers by, for example, providing compelling network services. A series of very popular network services are social networks that alert groups of members identified as friends about the current or recent activities of other members of the group. Such activities range from profiles of personal information, photos, music playing and other content rendering, and geographic location, among others.

These social services provide techniques for adding members to a group of friends of an individual member (called herein a “personal network”); but such techniques typically involve several steps. For example, many services require a first member (called herein an “inviter”) to search through registered members of the service to identify another member, to notify the other member (called herein an “invitee”) of an opportunity to join the personal network of the inviter for a particular social service (using a messaging channel, e.g., email, outside the service), requiring action by the invitee to launch the service, and then require further action by the invitee to accept or reject the invitation. Even more steps are involved if the invitee is not already a member of the social service. For example, the inviter is further asked to provide the invitee's identifier on a particular messaging channel (e.g., email), and send a message to the invitee with a link over a communications network to a registration page of the social service. The invitee must then establish a communications network connection with the service, register with the service, logon to the service, and then initiate an invitation with the inviter. These multiple-step techniques are a burden on both inviter and invitee, diminish the user experience for both, and hinder the establishment of social connections between users.

### Some Example Embodiments

Therefore, there is a need for a robust approach to join a personal network, with many fewer steps to extend and accept invitations to the personal network. In several embodiments, the robust approach involves in-service notice of an invitation to join a personal network. More generally, the approach involves in-application notice of a message sent via an independent messaging service.

According to one embodiment, a method comprises monitoring a messaging service for arrival of a message at an apparatus. The method also comprises determining whether the message indicates an installed application that is installed on the apparatus and is different from the messaging service. The method further comprises if the message indicates the installed application, initiating removal of the message from a queue of received messages for the external messaging service and selecting one or more actions for the application based on the message.

According to another embodiment, an apparatus comprising at least one processor, and at least one memory including computer program code, the at least one memory and the computer program code configured to, with the at least one processor, cause the apparatus to monitor a messaging service for arrival of a message at the apparatus. The apparatus is also caused to determine whether the message indicates an installed application that is installed on the apparatus and is different from the messaging service. The apparatus is further caused to if the message indicates the installed application, then initiate removal of the message from a queue of received messages for the external messaging service and selecting one or more actions for the application based on the message.

According to another embodiment, a computer-readable storage medium carrying one or more sequences of one or more instructions which, when executed by one or more processors, cause an apparatus to monitor a messaging service for arrival of a message at the apparatus. The apparatus is also caused to determine whether the message indicates an installed application that is installed on the apparatus and is different from the messaging service. The apparatus is further caused to if the message indicates the installed application, then initiate removal of the message from a queue of received messages for the external messaging service and selecting one or more actions for the application based on the message.

According to yet another embodiment, an apparatus comprises means for monitoring a messaging service for arrival of a message at an apparatus. The apparatus also comprises means for determining whether the message indicates an installed application that is installed on the apparatus and is different from the messaging service. The apparatus further comprises means for initiating removal of the message from a queue of received messages for the external messaging service and means for selecting one or more actions for the application based on the message, if the message indicates the installed application.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of in-application notification of an independent message, according to one embodiment;

FIG. 2A is a diagram of the components of user equipment capable of in-application notification of an independent message, according to one embodiment;

FIG. 2B is a diagram of a message for an application sent in an independent messaging service, according to an embodiment

FIG. 3 is a flowchart of a process for inviting a contact to join a personal network using an independent messaging service, according to one embodiment;

FIG. 4 is a flowchart of a process for presenting within an application a message sent from a corresponding application in an independent messaging service, according to one embodiment;

FIG. 5A is a flowchart of a process for presenting a message sent from an application through an independent messaging service when the corresponding application is not installed, according to one embodiment;

FIG. 5B is a flowchart of a process at a remote service for presenting a message sent in an independent messaging service when the application is not installed, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF SOME EMBODIMENTS

A method and apparatus for in-application notification of an independent message are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “application” refers to any process running on user or service provider equipment, including stand alone processes, client processes communicating with a server process hosted somewhere on a network, and the server processes. As also used herein, the term “independent message” refers to a message sent by an independent message service that is different from an application. However, the message may originate in an instance of the application. Furthermore, although various embodiments are described with respect to a social network service, such as maps with friends, it is contemplated that the approach described herein may be used with any application that involves sending messages among instances of the application using an independent message service.

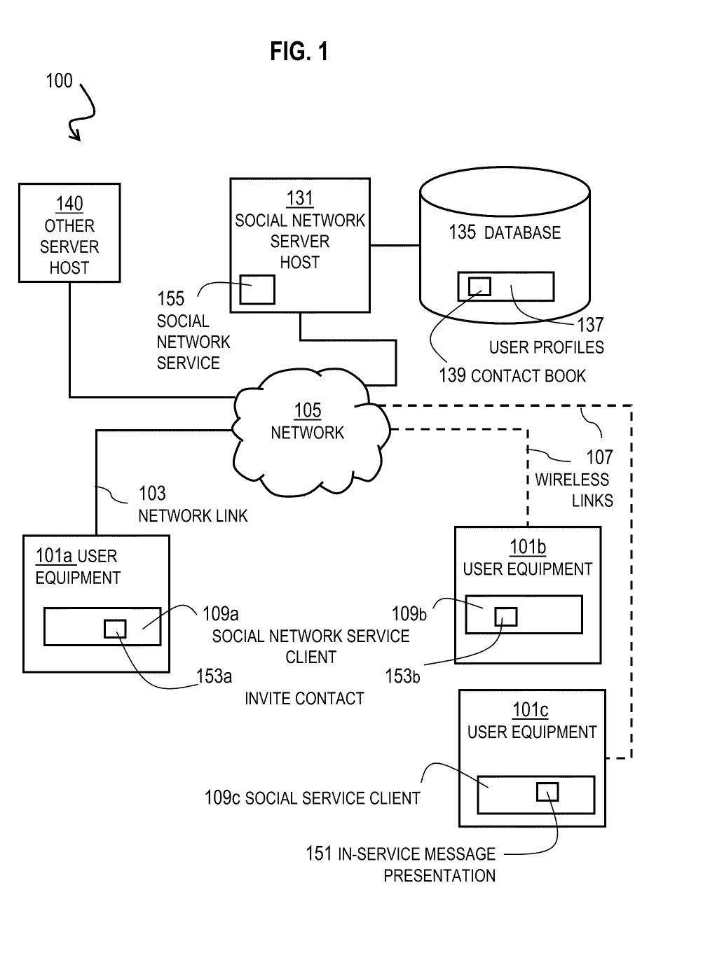

FIG. 1 is a diagram of a system 100 capable of in-application notification of an independent message, according to one embodiment. When one instance of an application executing on user equipment attempts to send a message to another instance of the application executing on different equipment, the application can develop its own messaging protocols, or employ one or more existing protocols. However, the application is also weighted with queuing those messages for sending when a connection is available and queuing received messages, as well. The overhead involved can increase costs of development, increase the demands on the computational resources of the equipment, and may render the application too demanding to even be installed on some mobile terminals.

To address this problem, a system 100 of FIG. 1 introduces the capability to utilize independent messaging services. Most mobile terminals with wireless links have one or more messaging services installed, such as the short messaging service (SMS) using the SMS protocol, or an instant messaging (IM) service or email, among others. According to the illustrated embodiment, the system 100 uses the independent messaging service to send messages between instances of the application. Then, an instance of the application renders the message within the application instead of within the messaging service. For purposes of illustration, the application is a social networking service client and the message is an invitation to join a subscriber's personal network (e.g., as a “friend”); but in other embodiments, any application may use an independent messaging service.

As shown in FIG. 1, the system 100 comprises user equipment (UE) 101a having connectivity to other UE 101b and UE 101c (collectively called UE 101) and one or more hosts (such as social network server host 131 and other server host 140) via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

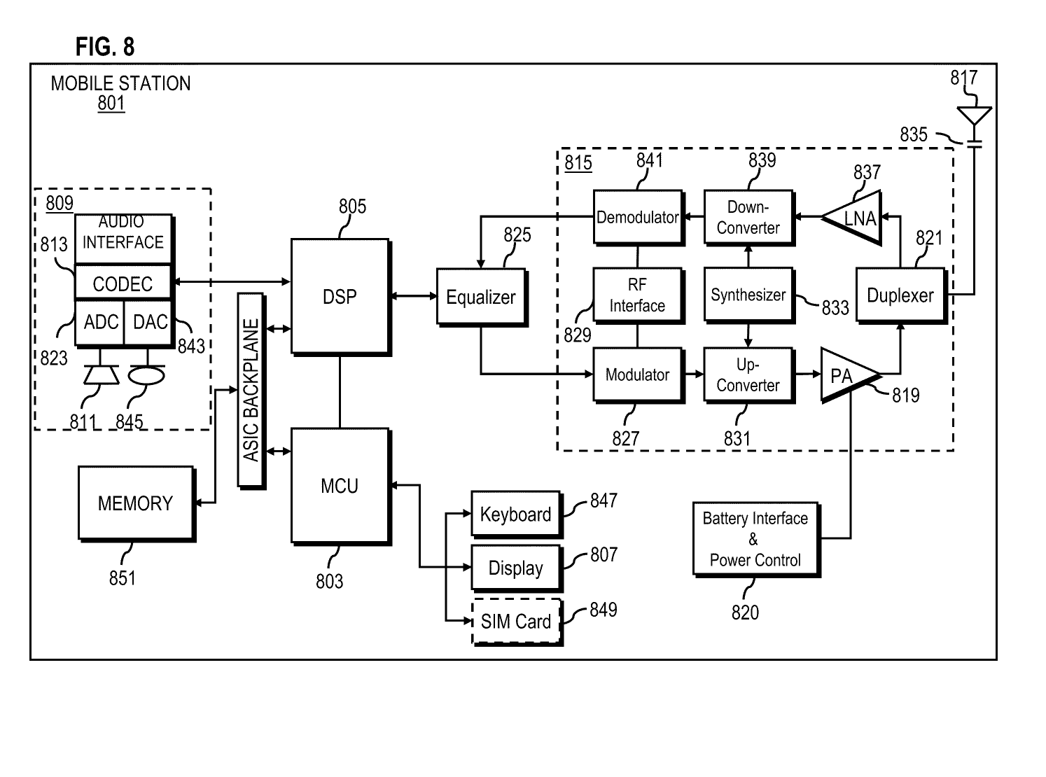

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). In the illustrated embodiment UE 101a is a fixed terminal in communication with network 105 via network link 103, and UE 101b and UE 101c are wireless mobile terminals, as described in more detail below with reference to FIG. 8, in communication with network 105 via wireless links 107.

By way of example, the UE 101, and hosts 131 and 140 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages

As shown in FIG. 1, the social network server host 131 includes social network service process 155 and is connected to database 135 holding user profiles data structures 137 for each subscriber to the social network service. The user profile 137 for a subscriber may include a contact book data structure 139 holding data that indicates contacts for the subscriber, such as cell phone numbers and email address and social network subscriber identifiers (IDs). The database 135 may reside on one or more nodes in direct or indirect communication with, or within, network 105.

UE 101a, UE 101b, and UE 101c include social network clients 109a, 109b, 109c, respectively, collectively called social network clients 109 hereinafter. According to the illustrated embodiment, one or more of the social network clients 109 includes an in-service message presentation module 151 that intercepts and presents independent messages sent from a social network server 155 or social network client on different UE. According to the illustrated embodiment, one or more of the social network clients 109 includes an invite contact module 153a, 153b (collectively referenced hereinafter as invite contact module 153) that allows a user of the UE, who is also a subscribes to the social network service, to invite a contact of the user to join the personal network of the user. For example, when the invitee accepts a friendship request, then the invitee will appear as a friend on the inviter's friends list and the inviter will appear as friend on the invitee's friends list. Accordingly, the inviter and invitee have decided to share their location with each other. Advantageously, location sharing only occurs upon mutual agreement.

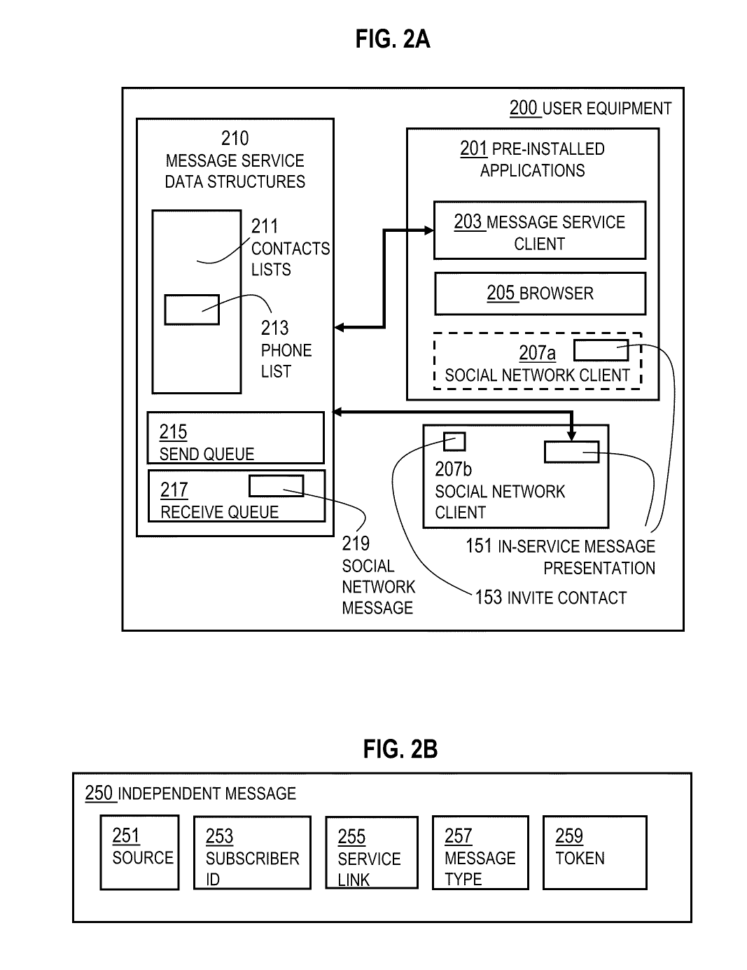

FIG. 2A is a diagram of the components of user equipment 200 capable of in-application notification of an independent message, according to one embodiment. Thus UE 200 is one embodiment of at least one of the UE 101 depicted in FIG. 1. By way of example, the UE 101c includes one or more components for providing in-service presentation of independent messages. It is contemplated that the functions of these components may be combined in one or more components or performed by other components of equivalent functionality. UE 200 includes zero or more pre-installed applications 201 and zero or more message service data structures 210. For purposes of illustration, it is assumed in the illustrated embodiment, that the pre-installed applications 201 include a message service client 203 (such as an SMS client or email client or IM client) and browser 205.

The message service client 203, uses one or more message service data structures 210, including a contacts list 211, a send queue 215 and a receive queue 217. The contacts list 211 holds data that identifies other users of the message service on other UE. In embodiments with an SMS message service, the contacts lists 211 include a cell phone list 213. These are contacts for the message service known to message service client 203; and zero or more of the contacts so indicated might not be subscribers of the social network known to social network client 207.The message service client 203 also constructs and maintains the send queue 215 to hold messages to be sent when the UE 200 is in communication with network 105, and the receive queue to hold messages received when the UE 200 was most recently in communication with network 105. This interaction is indicated by an arrow connecting message service client 203 to the message service data structures 210.

In the illustrated embodiment, the UE 200 also includes an executing social network client, either as a pre-installed social network client 207a, or a subsequently installed social network client 207b, collectively referenced hereinafter as social network client 207. As depicted in FIG. 1, the social network client 207 includes an in-service message presentation module 151 for independent messages associated with the social network client 207 and an invite contact module 153. An example independent message associated with the social network service is social network message 219 in receive queue 217.

According to the illustrated embodiment, the in-service message presentation module 151 monitors the receive queue or send queue 215 of an independent message service, or both, for a message associated with an application, such as social network message 219 received from a different UE 101. Once detected, the message, e.g. social network message 219, is removed from control of the message service, e.g., removed from the receive queue 217, and used as the basis of an interface of the application (e.g., an interface of social network client 207) presented to a user of UE 200. This interaction is indicated by an arrow connecting in-service message presentation module 151 to the message service data structures 210.

FIG. 2B is a diagram of a message 250 for an application sent in an independent messaging service, according to an embodiment. The message 250 is formatted according to the protocol used by the service, such as the SMS protocol. It is assumed for purposes of illustration that the message 250 is received at UE 101c; e.g., a social network message 219 is placed in receive queue 217 on UE 200. The message 250 includes a source field 251, a subscriber identifier (ID) field, a service link field 255, a message type field 257 and a token field 259.

The source field 251 holds data that indicates a message service source of the message 250, e.g., an email address or cell phone number of a message service client on a different device. For purposes of illustration, it is assumed that the source of message 250 is an SMS message service client on UE 101b; and that source field 251 holds data that indicates the cell phone number for UE 101b. In this embodiment, source field 251 is part of the SMS header.

The subscriber ID field 253 holds data that indicates a user of the application that uses the independent message service, e.g., a subscriber of the social network service. For example, in an SMS message a free text field is used to indicate a subscriber ID by which the sending user is known to the recipient user. For example, userA is a subscriber ID for a first user, e.g., an inviter, of the social network service who is using an SMS messaging service on a cell phone with a telephone number 444-555-6666. The source field 251 holds data indicating the source of the SMS message, cell phone number 444-555-6666, and the subscriber ID field 253 holds data that indicates “userA.”

The service link field 255 holds data that indicates a network address of a download page for the application, e.g., a universal resource identifier (URI) for the social network service 155. The data in service link field 255 can be used by a browser on the UE 200 to open a web page interface for the social network service 155.

The message type field 257 holds data that indicates how the message 250 is to be used by the application on receiving UE 200. For example, the data in the message type field 257 indicates whether the message 250 is an invitation to join a personal network of the inviter indicated in subscriber ID field 253, or some other type of message, e.g., an alert to a change in status of the subscriber. In some embodiments, all messages for a particular application are of the same type; and field 257 is omitted.

The token field 259 holds data that indicates a unique number so that a response to the message 250 can be associated with the message 250. For example, the sending node, e.g., UE 101b can distinguish between multiple responses to multiple earlier invitations because the response will have the same value in the token field 259 as the invitation being responded to.

Although a particular set of nodes, processes, fields, messages and data structures, such as databases, are shown in FIG. 1, FIG. 2A and FIG. 2B for purposes of illustration, in various other embodiments more or fewer nodes, processes, fields, messages and data structures are involved. Furthermore, although processes, fields, messages and data structures are depicted as particular blocks in a particular arrangement for purposes of illustration, in other embodiments each process, message, field or data structure, or portions thereof, may be separated or combined or arranged in some other fashion.

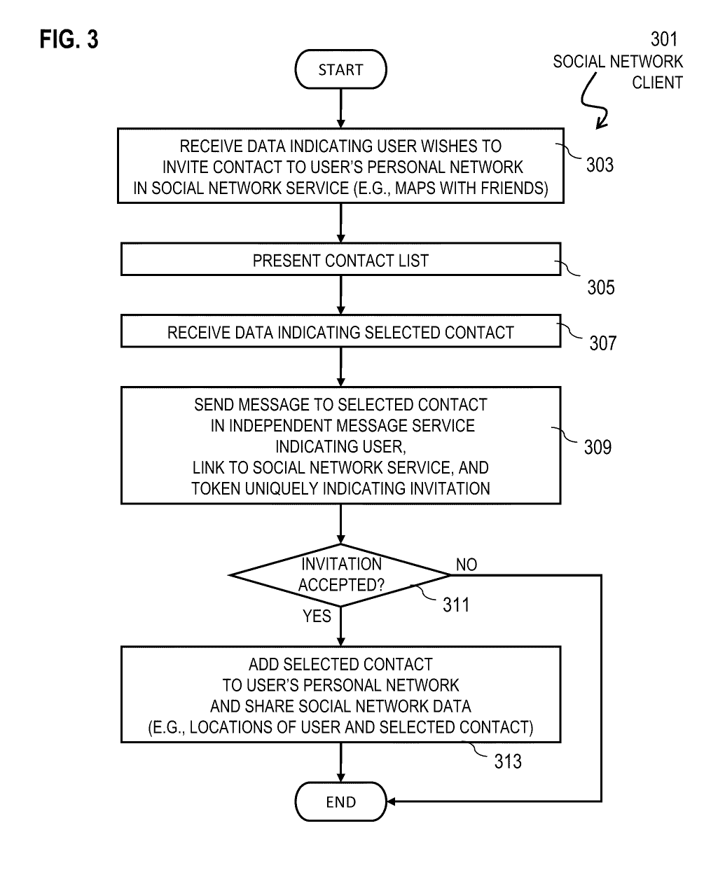

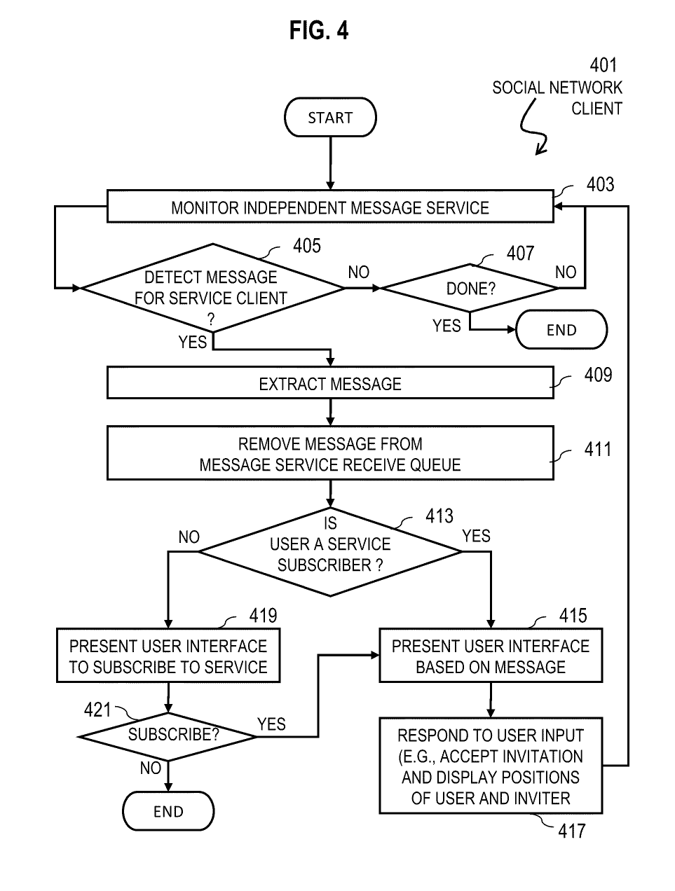

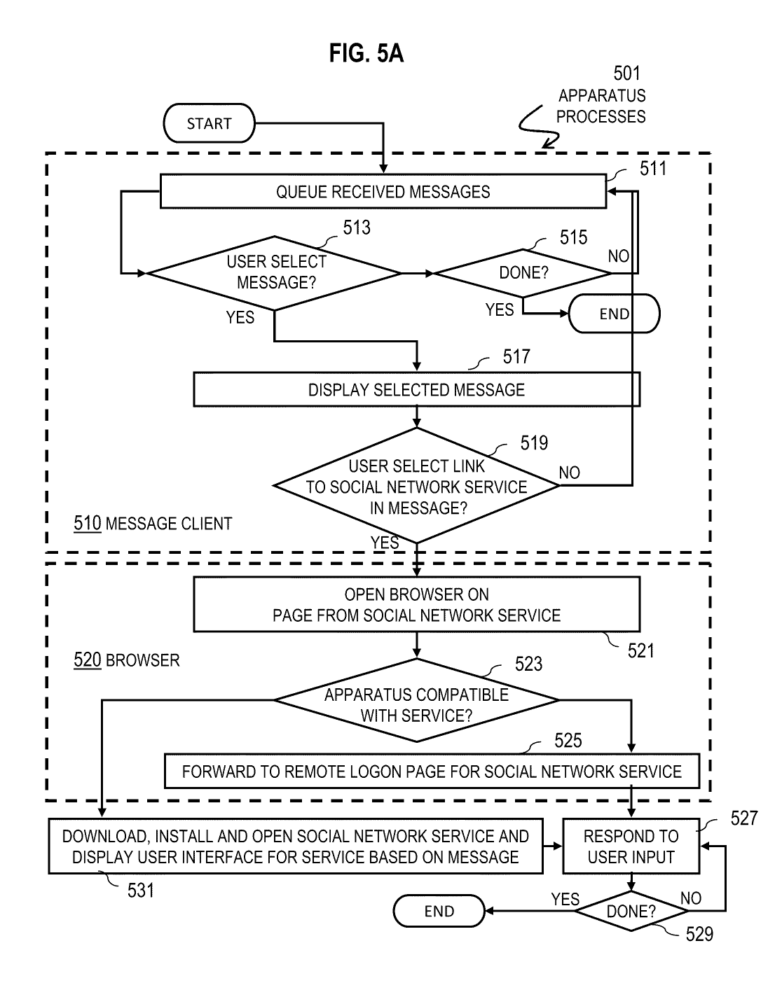

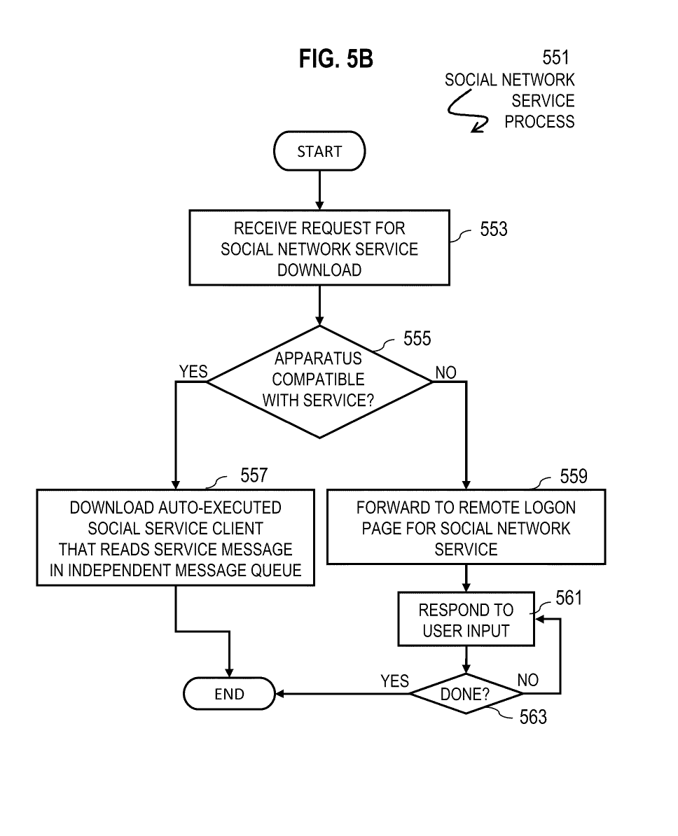

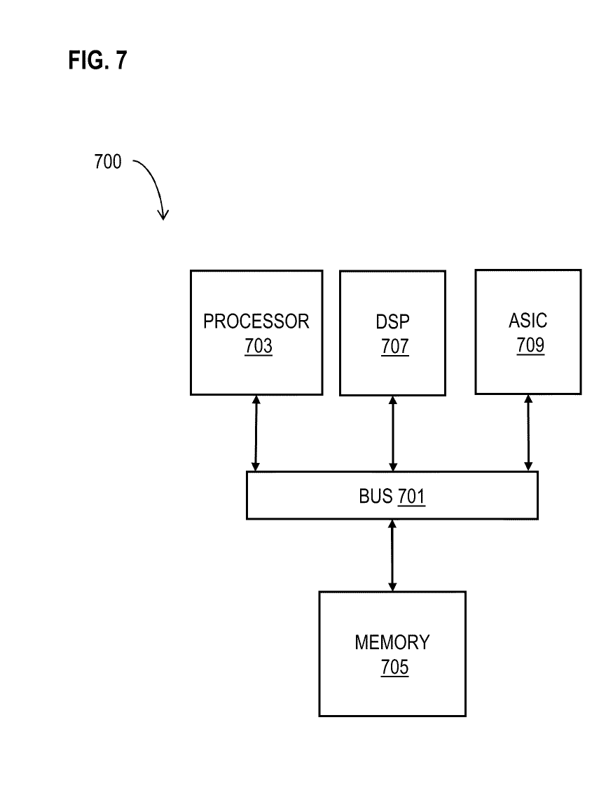

FIG. 3 is a flowchart of a process 301 for inviting a contact to join a personal network using an independent messaging service, according to one embodiment. In one embodiment, an invite contact module 153 in the social client process 109 performs the process 301; and is implemented in, for instance, a chip set including a processor and a memory as shown FIG. 7. Although steps in FIG. 3 and subsequent flow charts FIG. 4, FIG. 5A and FIG. 5B are shown in a particular order for purposes of illustration, in other embodiments, one or more steps may be performed in a different order or overlapping in time, in series or in parallel, or one or more steps may be omitted or added, or changed in some combination of ways.

In step 301, data is received that indicates a user who is a subscriber to the social network service wishes to add a contact (who might not be a subscriber) to the subscriber's personal network (e.g., add the contact as a location sharing friend to a maps-with-friends service). Any method may be used to receive this data, for example the data is received as user input resulting from depressing a physical key with a hard or soft label or by activating a virtual key using a pointing device on the UE 101b.

The user indicates a wish to add a contact to the user's personal network by highlighting, e.g., a menu item labeled “Add friend from phonebook.”. As a result, a cell phone serving as UE, e.g. UE 101b, receives data indicating the subscriber's desire to add a phonebook contact to the personal network of the subscriber.

In step 305, a contact list is presented to the user. For example, a phonebook list of the user of a cell phone is presented to the user. The user indicates a wish to add a contact to the user's personal network by highlighting, e.g., a menu item labeled “Add friend from phonebook.” As a result, a cell phone serving as UE, e.g. UE 101b, receives data indicating the subscriber's desire to add a phonebook contact to the personal network of the subscriber. When the UE is not a cell phone or other mobile terminal, there might not be a cell phone number for the UE and an email address may be used instead to identify either the user or the contact, or both.

In step 307, data is received that indicates a particular contact. Any method may be used to receive this data, as described above. In step 307, a cell phone serving as UE, e.g. UE 101b, receives data indicating the network address for a contact to invite to the personal network of the subscriber.

In step 309, a message is sent using an independent message service to the contact. The message indicates the sending user and the application on the contact's device that interprets the message, such as the social network service client. In the illustrated embodiment, the data indicating the application is a link, such as a URI, to a web server where the application can be downloaded. The message also includes a token to uniquely identify the message and match any responses to the message. For example, independent message 250 is sent to UE 101c during step 309. In an illustrated embodiment, the message is an SMS message indicating an invitation for the contact as invitee to join the personal network of the subscriber as inviter e.g., to share location in a maps with friends application.

In step 311, it is determined whether the invitation is accepted. For example, it is determined whether an independent message like 250 is received with data in message type field 257 indicating “accept” and value in token field 239 equal to the value in the token field 259 of the corresponding invitation message. If the message type field holds data that indicate “reject” then the process ends. If, instead the message type indicates “accept,” then in step 313 the selected contact is added to the user's personal network and the social network data is shared.

FIG. 4 is a flowchart of a process 401 for presenting within an application a message sent from another instance of the application through an independent messaging service, according to one embodiment. In one embodiment, an in-service message presentation module 151 in the social network client 109 performs the process 401; and is implemented in, for instance, a chip set including a processor and a memory as shown FIG. 7.

In step 403, the messages in the independent message service are monitored. This is an example of the general step of monitoring a messaging service for arrival of a message at an apparatus. For example, SMS message 219 in an SMS receive queue 217 is read.

In step, 405 it is determined whether a message for the service client is detected. This is an example of determining whether the message indicates an installed application that is installed on the apparatus and is different from the messaging service. For example, it is determined whether the data in the service link field 255 indicates the web page where the application doing the monitoring (e.g., the social network service client) can be downloaded. If not, then in step 407, it is determined whether the process is done. If done, then the process ends. Otherwise, step 403 and following are repeated to continue monitoring the messages in the independent message service.

If, in step 405, it is determined that a message for the service client is detected, then the message is presented within the application and removed from the message service, as described in the following steps. Thus, if the message indicates the installed application, then removal of the message from a queue of received messages for the external messaging service is initiated, and a user interface for the application is presented based on the message.

In step 409 the message is extracted, e.g., the useful fields of the message are extracted and stored in memory allocated to the application, e.g., memory allocated to the social network service client on UE 101c. In step 411, the message is removed from the message service receive queue. For example, the message 219 is removed from receive queue 217 by the in-service message presentation module 151. This can often be accomplished fast enough that a user of the UE 200 does not even see an indication of the message 219 within the message service. In some embodiments, an audible alert is sounded when the message 219 is placed in the receive queue 217, but the message does not appear in the message service. Instead a user interface of the application appears, as described below, and the user learns to associate the audible alert with the application interface.

In step 413, it is determined whether the user of the UE is a registered user of the application, e.g., a subscriber to the service, such as the social network service. In some embodiments involving stand alone applications, all users of an apparatus are considered registered users if the stand alone application is installed; and none are considered registered users if the stand alone application is not installed. For a client process of a service that requires registration, such as a social network service client, a user is a registered user if the user has registered with the service—such a user is a subscriber to the service. The client can tell if a user is a subscriber by contacting the service with the locally stored credentials for the user of the client.

If it is determined in step 413 that a user of the UE, e.g., a user of UE 101c, is a registered user, then in step 415 a user interface is presented to the user based on the message. For example, in response to receiving a SMS message indicating an invitation to share location data with a maps and friends service, the user is presented with a panel like panel 345a or panel 345b of FIG. 3B of the application, which indicates the inviter and the invitation (e.g., userA invites you to share location”). Thus an in-application interface is presented to the user instead of the independent message service. In some embodiments, step 415 includes starting the application, such as social network client 207 if it is not already executing. In these embodiments, the in-service message presentation module 151 at least is running in background mode to monitor the independent messages and launch the application, e.g., social network client 207.

In step 417, the application responds to user input. For example, the social network client responds to subscriber input to accept the invitation. For the map and friends client, the response includes displaying positions of the invited subscriber and the inviter subscriber. Control then passes back to step 403 to continue monitoring the independent messages.

If it is determined in step 413 that a user of the UE, e.g., a user of UE 101c, is not a registered user, then in step 419 a user interface is presented to the user that allows the user to subscribe to the service. Any method may be use to present this interface. In some embodiments, the user is presented with a logon screen and invited to create an account with the service.

In step 421, it is determined whether the user has subscribed to the service. For example, it is determined whether the user responded with input to create an account in response to the prompt on the logon screen. If not, then the response to the independent message is complete, the user will not subscribe; and there is no need for the in-service message presentation to continue to monitor the messages in step 403. If the user has subscribed to the service, then in step 415 and following, the user interface based on the message is presented to the user, as described above.

FIG. 5A is a flowchart of a process 501 for presenting a message sent from an application in an independent messaging service when the corresponding application is not installed, according to one embodiment. In one embodiment, a message client 510 performs some portion of the process 501, and a browser performs another portion of the process 501. In some embodiments, a third portion of process 501 is performed by an instance of the application on the UE, e.g., on UE 101c; and is implemented in, for instance, a chip set including a processor and a memory as shown FIG. 7.

In step 511, the message service client stores received messages in a receive queue, e.g., message service client 203 places received message 219 in receive queue 217. In step 513, it is determined whether a user of the UE has selected the received message. For example, it is determined if the user selected message 219 by pointing to it on a list of messages on a touch screen display. If not, it is determined in step 515 whether the user is done with the message service. If so, the message client 510 ends; otherwise, the message client 510 continues to queue received messages.

If, in step 513, it is determined that a user of the UE has selected the received message, then, in step 517, the received message is displayed e.g., on a display screen of the UE. For example, the data indicated in message 250 is presented on a screen of the mobile device, including the service link where the application can be downloaded or an icon representing the link.

In step 519, it is determined whether the user has selected the service link, e.g., by touching its location on a touch screen or clicking a soft key or button on a pointing device when a cursor is placed over the link. If not, then control passes back to step 511 to queue received messages and following steps, described above.

If the user has selected the service link, then the browser 520 (e.g., browser 205 on UE 200) opens on the apparatus and requests the web page indicated by the link. In step 521, the browser 520 displays the page where the application can be downloaded, e.g., a social service client download page from the social network service 155.

In step 523, it is determined whether the UE is compatible with the application, e.g., with the social network service client. If not, control passes to step 525. For example, to share position on the maps-with-friends service, the UE should include a Global Positioning System (GPS) receiver. If the UE does not include a GPS receiver, it is determined that the apparatus is not compatible and control passes to step 525.

In step 525, the browser 520 is directed to another page from the service, where the user can logon to the service and run it remotely. For example, the browser 520 on the UE 101c is directed to a logon page provided by service 155 on the host 131. The remote service 155 then responds to user input through browser 520 in step 527. In step 529, it is determined whether the user is done with the application. If so, the process ends; otherwise control passes back to step 527 to respond to further user input.

If it is determined, in step 523, that the UE is compatible with the application, e.g., with the social network service client, then control passes to step 531. In step 531, the application is downloaded, installed and launched to display a user interface based on the received independent message, either fully automatically, or with one or more interventions by a user of the apparatus. For example, the social network service client is automatically downloaded and installed on the UE 101c, and is launched automatically, and automatically presents the logon/register page to the user. After the user provides registration information, the user is automatically presented with the user interface based on the message, e.g., the invitation to join the personal network of userA on UE 101b.

In step 527, the local application responds to the user input, instead of the remote service described above with reference to step 527. When the user is done with input, the process ends, as determined in step 529, described above.

FIG. 5B is a flowchart of a process 551 at a remote service for presenting a message sent in an independent messaging service when the application is not installed, according to one embodiment. In one embodiment, a web interface module of a social network service 155 performs the process 551; and is implemented in, for instance, a chip set including a processor and a memory as shown FIG. 7.

In step 553, an HTTP request is received to download the social network service client. For example, an HTTP message sent by browser 205 on UE 101c is received. In step 555, it is determined whether the apparatus from which the request is sent is compatible with the service client. For example, a script or applet is downloaded to the requesting apparatus UE 101c to determine whether a GPS receiver is aboard and report back. If compatible, then in step 557 the application is downloaded for automatic installation and execution. The application is designed to automatically prompt the user for registration information, and in response to cull the independent message service receive queue for messages associated with the downloaded application. If found, the application presents the user interface based on the message, e.g., the invitation to share location with inviter subscriber, userA. The service process 155 is then done with the UE 101c.

If not compatible, then in step 559 the user's browser is redirected to a page of the service 155 used for remote logon and operation, e.g., an instance of the server is launched to interact with this one browser. In step 561, the instance of service 155 responds to user input at browser 520 and the HTTP messages sent by the browser to the instance of service 155. If user input is done, then the instance ends; otherwise, control passes back to step 561 to respond to more user input.

The processes and arrangements, according to certain embodiments, advantageously permit a user to join a personal network without executing many procedures that consume system and network resources (e.g., power and bandwidth).

The processes described herein for providing in-application notification of an independent message may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

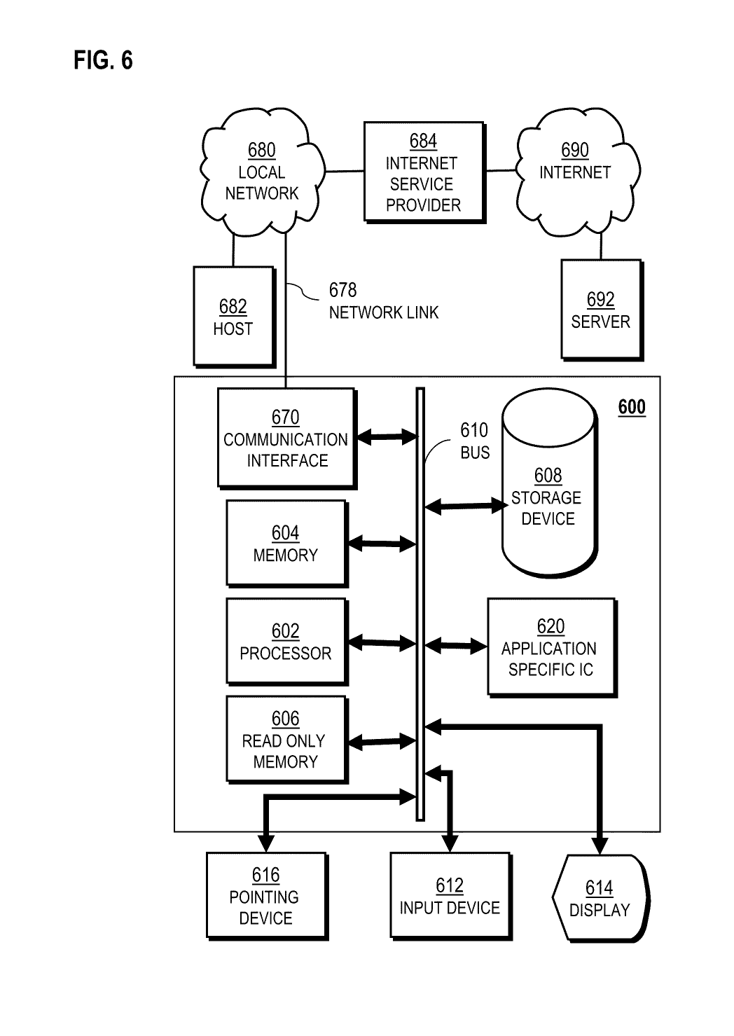

FIG. 6 illustrates a computer system 600 upon which an embodiment of the invention may be implemented. Computer system 600 is programmed (e.g., via computer program code or instructions) for in-application notification of an independent message as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related for in-application notification of an independent message. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for in-application notification of an independent message. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for in-application notification of an independent message, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for in-application notification of an independent message at the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 7 illustrates a chip set 700 upon which an embodiment of the invention may be implemented. Chip set 700 is programmed for in-application notification of an independent message as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein for in-application notification of an independent message. The memory 705 also stores the data associated with or generated by the execution of the inventive steps.

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 for in-application notification of an independent message. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
monitoring a messaging service for arrival of a message at an apparatus;
determining whether the message indicates an installed application that is installed on the apparatus and is different from the messaging service; and
if the message indicates the installed application, initiating removal of the message from a queue of received messages for the external messaging service and selecting one or more actions for the application based on the message.

2. A method of claim 1, wherein the application is a social network service and the message indicates an invitation to join a personal network of a subscriber of the social network service.

3. A method of claim 2, wherein the message further includes a token to uniquely identify the invitation.

4. A method of claim 2, wherein the social network service is a mapping service for sharing locations of subscribers among friends.

5. A method of claim 2, wherein the message is directed from the subscriber to a user who is either in a contact list of the subscriber or a list of telephone contacts for the subscriber.

6. A method of claim 2, wherein the one or more actions include presenting a user registration interface for registering a subscriber with the social network service if a user of the apparatus is not already a subscriber to the social network service.

7. A method of claim 1, wherein the message includes a link to a network resource where an application can be downloaded, the method further comprising:
if the message indicates an uninstalled application that is not installed on the apparatus, leaving the message in the queue of received messages for the external messaging service,
if the message indicates an uninstalled application and if a user of the apparatus activates the link, connecting to the network resource where the application can be downloaded,
if the message indicates an uninstalled application and if a user of the apparatus activates the link, downloading the application from the network resource, installing the application on the apparatus, and presenting a user interface for the application based on the message, and
if the message indicates an uninstalled application and if a user of the apparatus activates the link and the apparatus is incompatible with the application, connecting to a network resource where the application can be operated remotely.

8. A method of claim 1, further comprising:
presenting to a user of the apparatus a contact list stored on the apparatus;
determining user input indicating a contact from the contact list; and
initiating sending to the contact a message that indicates the user, a link to a network resource where the installed application can be downloaded, and an action for the installed application.

9. An apparatus comprising:
at least one processor; and
at least one memory including computer program code, the memory and the computer program code configured to, with the processor, cause the apparatus to perform at least the following:
monitor a messaging service for arrival of a message at the apparatus;
determine whether the message indicates an installed application that is installed on the apparatus and is different from the messaging service; and
if the message indicates the installed application, then initiate removal of the message from a queue of received messages for the external messaging service and selecting one or more actions for the application based on the message.

10. An apparatus of claim 9, wherein the application is a social network service and the message indicates an invitation to join a personal network of a subscriber of the social network service.

11. An apparatus of claim 10, wherein the message further includes a token to uniquely identify the invitation.

12. An apparatus of claim 10, wherein the social network service is a mapping service for sharing locations of subscribers among friends.

13. An apparatus of claim 10, wherein the message is directed from the subscriber to a user who is either in a contact list of the subscriber or a list of telephone contacts for the subscriber.

14. An apparatus of claim 10, wherein the one or more actions include presenting a registration user interface for registering a subscriber with the social network service if a user of the apparatus is not already a subscriber to the social network service.

15. An apparatus of claim 9, wherein the message includes a link to a network resource where an application can be downloaded, the apparatus being further cause to:
if the message indicates an uninstalled application that is not installed on the apparatus, leave the message in the queue of received messages for the external messaging service,
if the message indicates an uninstalled application and if a user of the apparatus activates the link, connect to the network resource where the application can be downloaded,
if the message indicates an uninstalled application and if a user of the apparatus activates the link, download the application from the network resource, installing the application on the apparatus, and presenting a user interface for the application based on the message, and
if the message indicates an uninstalled application and if a user of the apparatus activates the link and the apparatus is incompatible with the application, connect to a network resource where the application can be operated remotely.

16. An apparatus of claim 9, wherein the apparatus is further caused to:
present to a user of the apparatus a contact list stored on the apparatus;
determine user input indicating a contact from the contact list; and
initiate sending to the contact a message that indicates the user, a link to a network resource where the installed application can be downloaded, and an action for the installed application.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to perform at least the following:
monitoring a messaging service for arrival of a message at the apparatus;
determining whether the message indicates an installed application that is installed on the apparatus and is different from the messaging service; and
if the message indicates the installed application, then initiating removal of the message from a queue of received messages for the external messaging service and selecting one or more actions for the application based on the message.

19. A computer-readable storage medium of claim 18, wherein the application is a social network service and the message indicates an invitation to join a personal network of a subscriber of the social network service,
wherein the message further includes a token to uniquely identify the invitation,
wherein the social network service is a mapping service for sharing locations of subscribers among friends,
wherein the message is directed from the subscriber to a user who is either in a contact list of the subscriber or a list of telephone contacts for the subscriber, and
wherein the one or more actions include presenting a registration user interface for registering a subscriber with the social network service if a user of the apparatus is not already a subscriber to the social network service.

20. A computer-readable storage medium of claim 1, wherein the message includes a link to a network resource where an application can be downloaded, the method further comprising:
if the message indicates an uninstalled application that is not installed on the apparatus, leaving the message in the queue of received messages for the external messaging service,
if the message indicates an uninstalled application and if a user of the apparatus activates the link, connecting to the network resource where the application can be downloaded,
if the message indicates an uninstalled application and if a user of the apparatus activates the link, downloading the application from the network resource, installing the application on the apparatus, and presenting a user interface for the application based on the message, and
if the message indicates an uninstalled application and if a user of the apparatus activates the link and the apparatus is incompatible with the application, connecting to a network resource where the application can be operated remotely.
